(19) United States
(12) Patent Application Publication
(10) Pub. No.: US 2007/0252922 A1
(43) Pub. Date: Nov. 1, 2007

(54) Liquid crystal display device

(75) Inventor: Eiji Oohira, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays Ltd.

(21) Appl. No.: 11/727,857

(22) Filed: Mar. 28, 2007

(30) Foreign Application Priority Data
Apr. 28, 2006 (JP) 2006-125056

(51) Int. Cl. G02F 1/1333

(52) U.S. Cl. 349/58

(57) ABSTRACT

The present invention realizes the miniaturization of a profile size of a liquid crystal display device. A liquid crystal display device includes a liquid crystal display panel which includes a pair of substrates and liquid crystal sandwiched between the pair of substrates; a backlight which is arranged on a side of the liquid crystal display panel opposite to a viewer, the backlight having a frame-like mold; and a pair of frames which are arranged along two longitudinal sides of the liquid crystal display panel and sandwiches the liquid crystal display panel and the backlight. Each frame of the pair of frames includes a first plate-like member, a second plate-like member, and a third plate-like member which connects one end of the first plate-like member and one end of the second plate-like member. The pair of frames holds the liquid crystal display panel and the frame-like mold which are inserted into the inside of a space defined by the first plate-like member, the second plate-like member and the third plate-like member by sandwiching the liquid crystal display panel and the frame-like mold using the first plate-like member and the second plate-like member.

The present application claims priority from Japanese application JP2006-125056 filed on Apr. 28, 2006, the content of which is hereby incorporated by reference into this application.

### BACKGROUND OF THE INVENTION

1. Field of the Invention

The present invention relates to a liquid crystal display device, and more particularly to a technique which is effectively applicable to a backlight which houses a light guide plate, a group of optical sheets and the like therein.

2. Description of Related Arts

A liquid crystal display module of a TFT (Thin Film Transistor) type which possesses a miniaturized liquid crystal display panel having the number of sub pixels amounting to approximately 240×320×3 in a color display has been popularly used as a display part of a portable equipment such as a mobile phone.

In general, the liquid crystal display module includes a liquid crystal display panel and a backlight which radiates light to the liquid crystal display panel. However, with respect to the liquid crystal display module which is used as a display part of a portable equipment such as a mobile phone, the backlight is constituted of a resin mold frame (hereinafter, referred to as a mold), a group of optical sheets and a light guide plate which are arranged in the inside of the mold, and a reflection sheet which is arranged on a lower side of the light guide plate.

Recently, the liquid crystal display module for a mobile phone adopts the structure which eliminates a bottom surface of the mold as a main stream to satisfy a demand for the reduction of thickness of the liquid crystal display module.

FIG. 14A and FIG. 14B are views showing the schematic structure of a liquid crystal display module for a conventional mobile phone, wherein FIG. 14A is a front view of the liquid crystal display module, and FIG. 14B is a side view of the liquid crystal display module. Further, FIG. 15 is a cross-sectional view of an essential part taken along a line A-A′ in FIG. 14A.

As shown in the cross-sectional structure shown in FIG. 15, a backlight includes a frame-like mold 20, a group of optical sheets 5 which is arranged in the inside of the mold 20, a light guide plate 6, a white light emitting diode (a light source, not shown in the drawing) which is arranged on one side surface (an incident surface) of the light guide plate 6, and a reflection sheet 7 which is fixed to a lower side of the mold 20 using a pressure-sensitive adhesive double-coated tape. Here, the group of optical sheets 5 is constituted of an upper diffusion sheet 5a, two lens sheets (5b, 5c) and a lower diffusion sheet 5d.

Further, the liquid crystal display panel 10 includes a pair of transparent substrates (for example, glass substrates or the like) (2a, 2b), liquid crystal which is sandwiched between the pair of substrates, an upper polarizer 1 which is adhered to an upper surface (a display screen) of the substrate 2a, and a lower polarizer 3 which is adhered to a lower surface (a backlight-side surface) of the substrate 2b.

Further, a semiconductor chip (DRV) which constitutes a driver or the like is mounted on the glass substrate 2b. Here, symbol FPC indicates a flexible printed circuit board which supplies control signals or the like to the semiconductor chip (DRV). The flexible printed circuit board (FPC) has another end thereof folded back and arranged on a back side of the backlight.

As shown in FIG. 15, the mold 20 has a side wall 20a, and the liquid crystal display panel 10 is fixed to a stepped portion which is formed on an inner side of the side wall 20a of the mold 20 using a pressure-sensitive adhesive double-coated tape 9. That is, the example shown in FIG. 15 adopts the structure in which the substrate 2b of the liquid crystal display panel 10 is fixed to the stepped portion of the mold 20 using the pressure-sensitive adhesive double-coated tape 9, and the lower polarizer 3 is made to fall into the inside of the mold 20.

FIG. 16A and FIG. 16B are views showing the schematic structure of another example of the liquid crystal display module for a conventional mobile phone, wherein FIG. 16A is a front view of the liquid crystal display module, and FIG. 16B is a side view of the liquid crystal display module. Further, FIG. 17 is a cross-sectional view of an essential part taken along a line B-B′ in FIG. 16A.

The liquid crystal display module shown in FIG. 16A, FIG. 16B and FIG. 17 differs from the liquid crystal display module shown in FIG. 14A, FIG. 14B and FIG. 15 with respect to a point that the liquid crystal display module shown in FIG. 16A, FIG. 16B and FIG. 17 adopt the structure which joins an upper frame 31 and a lower frame 32 from the outside thus surrounding the liquid crystal display panel 10 and the backlight from the outside. However, the liquid crystal display module shown in FIG. 16A, FIG. 16B and FIG. 17 is equal to the liquid crystal display module shown in FIG. 14A, FIG. 14B and FIG. 15 with respect to points except for the above-mentioned point. Here, numeral 16 indicates a pressure-sensitive adhesive double-coated tape which connects the upper frame 31 and the substrate 2a to each other.

Further, as shown in FIG. 18, when it is necessary to establish the conductivity (conductance) between the upper frame 31 and the liquid crystal display panel 10, to absorb irregularities of thicknesses of members and a thickness of the liquid crystal display panel 10, a conductive member (a tape or the like having both properties of adhesiveness and conductivity or a conductive sheet or the like having resiliency such as conductive rubber) 17 is, in general, sandwiched between the substrate 2a of the liquid crystal display panel 10 and the upper frame 31. Here, FIG. 18 is a cross-sectional view of an essential part showing the cross-sectional structure of a portion corresponding to a cross-sectional position taken along a line C-C′ in FIG. 16A. Further, numeral 8 indicates a white light emitting diode (light source) which is arranged on one side surface (incident surface) of the light guide plate 6.

Besides the above-mentioned constitution, as the frame, following patent document 1 describes, different from a liquid crystal display panel for a mobile phone of the present invention, an L-shaped split frame or I-shaped split frame which is used in a large-sized liquid crystal display panel in which the frame has a U-shaped cross section.

As the prior art document related to the present invention, a following document is named.

### Patent Document 1: JP-A-2002-23648

### SUMMARY OF THE INVENTION

However, as in the case of the above-mentioned liquid crystal display module shown in FIG. 14A, FIG. 14B and FIG. 15, when one substrate 2b of a liquid crystal display panel 10 is fixed to the frame-like mold 20 of the backlight using the pressure-sensitive adhesive double-coated tape 9, to firmly adhere the liquid crystal display panel 10 to the mold 20 by way of the pressure-sensitive adhesive double-coated tape 9, it is necessary to ensure a clearance (indicated by KA in FIG. 15) in the inside of the mold 20.

This clearance (KA) is a requisite space to be ensured in view of sheets 5 in the inside of the mold 20, a range of irregularities of thickness of the light guide plate 6, and the range of the irregularities of a thickness of the mold 20. Although the total thickness of the liquid crystal display module may be further decreased by reducing a volume of such a space, the reduction of the thickness of the liquid crystal display module cannot be achieved with the fixing structure using the pressure-sensitive adhesive double-coated tape.

Assuming a case in which the clearance (KA) in the inside of the mold 20 cannot be ensured, when the thickness of the sheets 5 in the inside of the mold 20 or the thickness of the light guide plate 6 in the inside of the mold 20 is decreased or the thickness of the mold 20 is increased, there arises no problem. However, when the thickness of the sheets 5 in the inside of the mold 20 or the thickness of the light guide plate 6 in the inside of the mold 20 is increased or the thickness of the mold 20 is decreased, there exists a drawback that the liquid crystal display panel 10 cannot reach the mold 20 (that is, the pressure-sensitive adhesive double-coated tape 9).

Further, as in the above-mentioned liquid crystal display module shown in FIG. 16A, FIG. 16B and FIG. 17, when the liquid crystal display panel 10 is fixed to the frame-like mold 20 of the backlight using the upper frame 31 and the lower frame 32, the liquid crystal display module adopts the structure which joins the upper frame 31 and the lower frame 32 from the outside for surrounding the liquid crystal display panel 10 and the mold 20 from the outside and hence, when the thickness of the sheets 5 in the inside of the mold 20 or the thickness of the light guide plate 6 in the inside of the mold 20 is increased, it is possible to suppress (absorb) an increased amount of thickness.

However, when the thicknesses of the sheets 5 and the light guide plate 6 in the inside of the mold 20 are decreased, (when the thicknesses of the sheets 5 and the light guide plate 6 are changed in the direction that the clearance is generated in the inside of the mold 20), since the upper frame 31 and the lower frame 32 have no resiliency, these frames cannot absorb the change of the thicknesses whereby the sheets 5 and the light guide plate 6 are arranged in the inside of the upper frame 31 and the lower frame 32 with a play. Accordingly, it is necessary to use the pressure-sensitive adhesive double-coated tape together with such a structure thus giving rise to a drawback that the use of tape cannot be eliminated.

Further, with respect to the structure which interposes a conductive member 17 between the liquid crystal display panel 10 and the upper frame 31, as indicated by symbol B in FIG. 18, a position of the upper frame 31 is arranged above an upper polarizer 1 and hence, there exists a drawback that the structure impedes the reduction of thickness of the liquid crystal display module.

The present invention has been made to overcome the drawbacks of the related art, and it is an advantage of the present invention to provide a technique which can realize the miniaturization of a profile size of a liquid crystal display device.

The above-mentioned and other advantages and novel features of the present invention will become apparent from the description of this specification and attached drawings.

To briefly explain the summary of the typical inventions among inventions disclosed in this specification, they are as follows.

(1) A liquid crystal display device includes a liquid crystal display panel which includes a pair of substrates and liquid crystal sandwiched between the pair of substrates; a backlight which is arranged on a side of the liquid crystal display panel opposite to a viewer, the backlight having a frame-like mold; and a pair of frames which are arranged along two longitudinal sides of the liquid crystal display panel and sandwiches the liquid crystal display panel and the backlight, wherein each frame of the pair of frames includes a first plate-like member, a second plate-like member, and a third plate-like member which connects one end of the first plate-like member and one end of the second plate-like member, and the pair of frames holds the liquid crystal display panel and the frame-like mold which are inserted into the inside of a space defined by the first plate-like member, the second plate-like member and the third plate-like member by sandwiching the liquid crystal display panel and the frame-like mold using the first plate-like member and the second plate-like member.

(2) In the liquid crystal display device having the above-mentioned constitution (1), a projecting portion which projects toward the first plate-like member is formed on the second plate-like members of the pair of frames, a recessed portion is formed in the frame-like mold of the backlight, and the projecting portion which is formed on the second plate-like member of the frame is inserted into the inside of the recessed portion formed on the frame-like mold of the backlight.

(3) In the liquid crystal display device having the above-mentioned constitution (2), the frame-like mold of the backlight has a guide groove which is continuously formed to be communicated with the recessed portion from a side surface of the frame-like mold.

(4) In the liquid crystal display device having any one of the above-mentioned constitutions (1) to (3), the pair of frames is not brought into direct contact with each other.

(5) In the liquid crystal display device having any one of the above-mentioned constitutions (1) to (4), the pair of frames respectively has a same shape.

(6) In the liquid crystal display device having any one of the above-mentioned constitutions (1) to (5), the liquid crystal display panel includes an upper polarizer over the substrate on the viewer side out of the pair of substrates, and the frame is arranged in a region outside a region in which the upper polarizer is arranged.

(7) In the liquid crystal display device having the above-mentioned constitution (6), the liquid crystal display panel includes a semiconductor chip on the substrate opposite to the viewer out of the pair of substrates, and the frame is arranged in a region outside a region in which the upper polarizer is arranged and a region outside a region in which the semiconductor chip is arranged.

(8) In the liquid crystal display device having any one of the above-mentioned constitutions (1) to (7), the pair of frames is made of metal, and the pair of frames is brought into contact with the substrate of the liquid crystal display panel on the viewer side.

(9) In the liquid crystal display device having any one of the above-mentioned constitutions (1) to (8), the pair of frames is arranged to cover the liquid crystal display panel except for a display part of the liquid crystal display panel.

(10) In the liquid crystal display device having the above-mentioned constitution (9), the pair of frames has portions of one frame and another frame which face each other formed in a corrugated shape, and the corrugated shape is configured such that convex portions of one frame out of the pair of frames is inserted into the inside of recessed portions of another frame of the pair of frames.

(11) In the liquid crystal display device having the above-mentioned constitution (9) or (10), the liquid crystal display device includes a flexible printed circuit board which has one end thereof fixed to an end portion of the substrate of the liquid crystal display panel on a side opposite to a viewer and another end thereof arranged on a back side of the backlight, and the pair of frames is arranged to cover the flexible printed circuit board.

(12) In the liquid crystal display device having any one of the above-mentioned constitutions (1) to (8), the pair of frames is arranged on longitudinal end portions of the liquid crystal display panel to cover the longitudinal end portion of the liquid crystal display panel along the longitudinal direction of the liquid crystal display panel.

(13) In the liquid crystal display device having any one of the above-mentioned constitutions (1) to (8), the pair of frames is arranged only in the vicinity of a stepped portion between one substrate and another substrate of the liquid crystal display panel in a state that the pair of frames is overlapped to the stepped portion.

(14) In the liquid crystal display device having the above-mentioned constitution (13), the pair of frames sets a length of the first plate-like member larger than a length of the second plate-like member.

(15) In the liquid crystal display device having any one of the above-mentioned constitutions (1) to (14), the liquid crystal display device includes a lower frame, and the liquid crystal display panel, the backlight and the pair of frames are housed in the inside of the lower frame.

(16) In the liquid crystal display device having any one of the above-mentioned constitutions (1) to (15), the liquid crystal display panel has the substrate on a side opposite to a viewer fixed to a surface of the frame-like mold on the viewer side, a side surface of the liquid crystal display panel is retracted toward the inside of the frame-like mold than a side surface of the frame-like mold, and the liquid crystal display panel and the frame-like mold are housed in the inside of the frame without interposing a resin between the side surface of the liquid crystal display panel and the pair of frames.

(17) In the liquid crystal display device having the above-mentioned constitution (16), a distance between a side surface of the frame-like mold and a side surface of the liquid crystal display panel is set to a value equal to or more than 0.3 mm and equal to or less than 1 mm.

(18) In the liquid crystal display device having any one of the above-mentioned constitutions (1) to (17), the liquid crystal display panel includes a lower polarizer on the substrate on a side opposite to the viewer, and the liquid crystal display panel is fixed to a surface of the frame-like mold on the viewer side in a region ranging from the outside of the lower polarizer to an end portion of the liquid crystal display panel.

(19) In the liquid crystal display device having any one of the above-mentioned constitutions (1) to (18), the liquid crystal display panel is fixed to a surface of the frame-like mold on the viewer side using a pressure-sensitive adhesive double-coated tape.

To briefly explain advantageous effects obtained by the typical inventions among the inventions disclosed in this specification, they are as follows.

That is, according to the liquid crystal display device of the present invention, it is possible to realize the miniaturization of a profile size of a liquid crystal display device.

### BRIEF DESCRIPTION OF THE DRAWINGS

FIG. 1 is a front view showing the schematic structure of a liquid crystal display module for a mobile phone of an embodiment 1 according to the present invention;

FIG. 2 is a cross-sectional view of an essential part taken along a line A-A′ in FIG. 1;

FIG. 3 is a cross-sectional view of an essential part showing the cross-sectional structure of the liquid crystal display module shown in FIG. 1;

FIG. 4 is a perspective view for explaining a metal frame shown in FIG. 1;

FIG. 5 is a view for explaining a resilient action of a metal frame which has a cross section thereof formed in a U shape;

FIG. 6 is a view showing a modification of the metal frames shown in FIG. 1;

FIG. 7A and FIG. 7B are views showing another modification of the metal frames shown in FIG. 1;

FIG. 8A and FIG. 8B are views showing the schematic structure of a liquid crystal display module for a mobile phone of an embodiment 2 according to the present invention, wherein FIG. 8A is a front view of the liquid crystal display module, and FIG. 8B is a back view of the liquid crystal display module;

FIG. 9A to FIG. 9C are views showing the schematic structure of a liquid crystal display module for a mobile phone of an embodiment 3 according to the present invention, wherein FIG. 9A is a front view of the liquid crystal display module, FIG. 9B is a back view of the liquid crystal display module, and FIG. 9C is a cross-sectional view of an essential part of the liquid crystal display module;

FIG. 10A and FIG. 10B are views showing the schematic structure of a modification of the liquid crystal display module for a mobile phone of the embodiment 3 according to the present invention, wherein FIG. 10A is a front view of the liquid crystal display module, and FIG. 10B is a back view of the liquid crystal display module;

FIG. 11 is a cross-sectional view of an essential part for explaining a backlight of a liquid crystal display module for a mobile phone of an embodiment 4 according to the present invention;

FIG. 12 is a cross-sectional view of an essential part for explaining a modification of a mold shown in FIG. 11;

FIG. 13 is a cross-sectional view of an essential part for explaining another modification of the mold shown in FIG. 11;

FIG. 14A and FIG. 14B are views showing the schematic structure of a liquid crystal display module for a conventional mobile phone, wherein FIG. 14A is a front view of the liquid crystal display module, and FIG. 14B is a side view of the liquid crystal display module;

FIG. 15 is a cross-sectional view of an essential part taken along a line A-A′ in FIG. 14A;

FIG. 16A and FIG. 16B are views showing the schematic structure of another example of the liquid crystal display module for the conventional mobile phone, wherein FIG. 16A is a front view of the liquid crystal display module, and FIG. 16B is a side view of the liquid crystal display module;

FIG. 17 is a cross-sectional view of an essential part taken along a line B-B′ in FIG. 16A;

FIG. 18 is a cross-sectional view of an essential part showing the cross-sectional structure of the liquid crystal display module for the conventional mobile phone;

FIG. 19A and FIG. 19B are views for explaining drawbacks of the conventional liquid crystal display module;

FIG. 20A and FIG. 20B are views for explaining drawbacks of the conventional liquid crystal display module; and

FIG. 21A and FIG. 21B are views for explaining drawbacks of the conventional liquid crystal display module.

### DESCRIPTION OF THE PREFERRED EMBODIMENTS

Hereinafter, embodiments of the present invention are explained in detail in conjunction with drawings.

Here, in all drawings for explaining the embodiments, parts having identical functions are indicated by same symbols and their repeated explanation is omitted.

### Embodiment 1

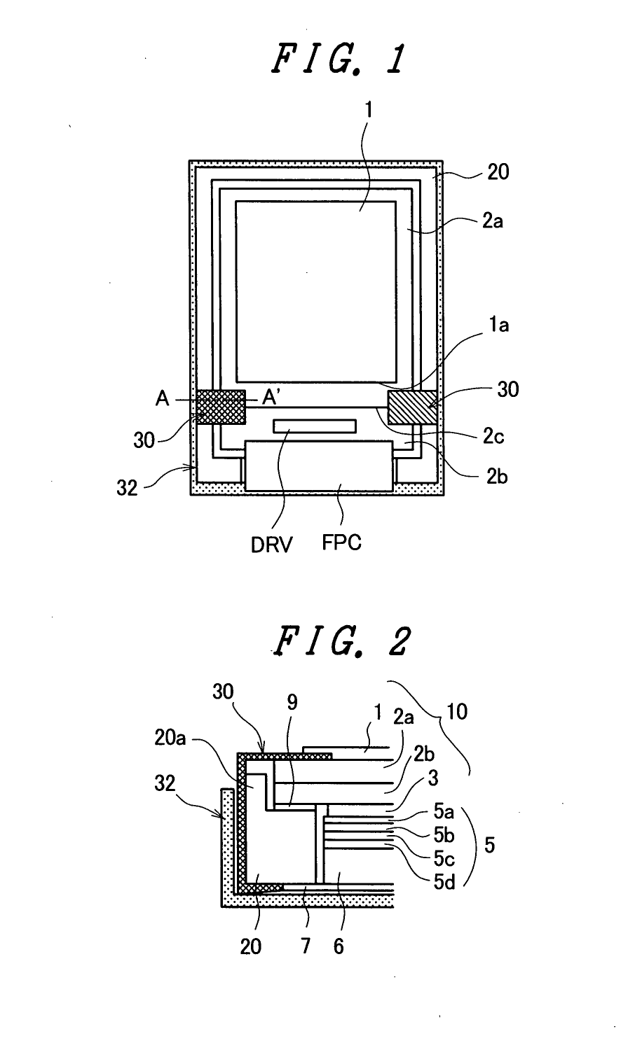

FIG. 1 is a front view showing the schematic structure of a liquid crystal display module for a mobile phone of an embodiment 1 according to the present invention. Further, FIG. 2 is a cross-sectional view of an essential part taken along a line A-A′ in FIG. 1.

As shown in FIG. 2, also in this embodiment, a backlight includes a resin-made mold 20, a group of optical sheet 5 which is arranged in the inside of the mold 20, a light guide plate 6, white light emitting diodes (a light source, not shown in the drawing) which are arranged on one side surface (incident surface) of the light guide plate 6, and a reflection sheet 7 which is fixed to a lower side of the mold 20 using a pressure-sensitive adhesive double-coated tape. Here, the group of optical sheets 5 is, for example, constituted of an upper diffusion sheet 5a, two lens sheets (5b, 5c) and a lower diffusion sheet 5d. The number of the optical sheets which constitutes the group of optical sheets 5 and kinds of the optical sheets are not limited to the above-mentioned upper diffusion sheet 5a, two lens sheets (5b, 5c) and lower diffusion sheet 5d.

A liquid crystal display panel 10 is configured such that a transparent substrate (also referred to as a TFT substrate) 2b which mounts pixel electrodes, thin film transistors and the like thereon, for example, and the transparent substrates (also referred to as counter substrates) 2a which forms color filters and the like thereon, for example, are overlapped to each other with a predetermined gap therebetween, both substrates are adhered to each other using a sealing material which is formed in a frame-like shape in the vicinity of a peripheral portion between both substrates, and liquid crystal is filled and sealed in the inside of the sealing material between both substrates through a liquid crystal filling opening formed in a portion of the sealing material.

Further, a liquid crystal display panel 10 includes an upper polarizer 1 which is adhered to an upper surface (display surface) of another substrate 2a on a viewer side out of a pair of transparent substrates, and a lower polarizer 3 which is adhered to a lower surface (backlight-side surface) of one substrate 2b on a side remote from the viewer out of the pair of transparent substrates.

On the substrate 2b, a semiconductor chip (DRV) which constitutes a driver or the like is mounted. Further, a flexible printed circuit board which supplies control signals or the like to the semiconductor chip (DRV) is also mounted on the substrate 2b. Here, although not shown in FIG. 1, the flexible printed circuit board (FPC) has another end thereof folded back and arranged on a back side of the backlight.

As shown in FIG. 2, also in this embodiment, the mold 20 has a side wall 20a, and the liquid crystal display panel 10 is fixed to a stepped portion formed on an inner side of the side wall 20a of the mold 20 using a pressure-sensitive adhesive double-coated tape 9.

In this embodiment, the backlight and the liquid crystal display panel 10 which is arranged above the backlight are held by a pair of metal frames 30. Further, the whole liquid crystal display module (the liquid crystal display panel 10 and the backlight which are held by the pair of the metal frames 30) is arranged in the inside of a lower frame 32.

Here, the pair of metal frames 30 is provided for holding the liquid crystal display panel 10 and the backlight or for making the substrate 2a of the liquid crystal display panel 10 and the metal frame 30 conductive with each other, while the lower frame 32 is provided for increasing a strength (rigidity) of the whole liquid crystal display module. Accordingly, when it is unnecessary to increase the strength (rigidity) of the whole liquid crystal display module, the lower frame 32 is not necessary.

Here, to achieve the reduction of cost of the metal frames 30 and to prevent erroneous mounting of the pair of metal frames 30 between the left and right sides, it is preferable to form the pair of metal frames 30 which are used as an upper frame into the same shape.

As shown in FIG. 1, the pair of metal frames 30 is arranged in a portion which includes a stepped portion between the substrate 2a and the substrate 2b of the liquid crystal display panel 10 and, at the same time, in a region outside a region in which an upper polarizer 1 is arranged and in a region outside a region on which a semiconductor chip (DRV) is formed.

Accordingly, the metal frame 30 is brought into contact with the substrate 2a of the liquid crystal display panel 10. Accordingly, it is possible to prevent the occurrence of the phenomenon that the substrate 2a is charged with static electricity and an abnormal display is performed on the liquid crystal display panel 10.

That is, a protective film is laminated to the upper polarizer 1 and, in an actual use of the product, it is necessary to peel off the protective film. However, when the protective film is peeled off, static electricity is generated. When the substrate 2a is charged with the static electricity, an abnormal display is performed on the liquid crystal display panel 10. Accordingly, conventionally, to eliminate the static electricity, a transparent conductive film (for example, ITO (Indium-Tin-Oxide) film) is formed on the substrate 2a of the liquid crystal display panel 10, and the transparent conductive film is electrically connected with a predetermined terminal on the substrate 2b using a conductive resin.

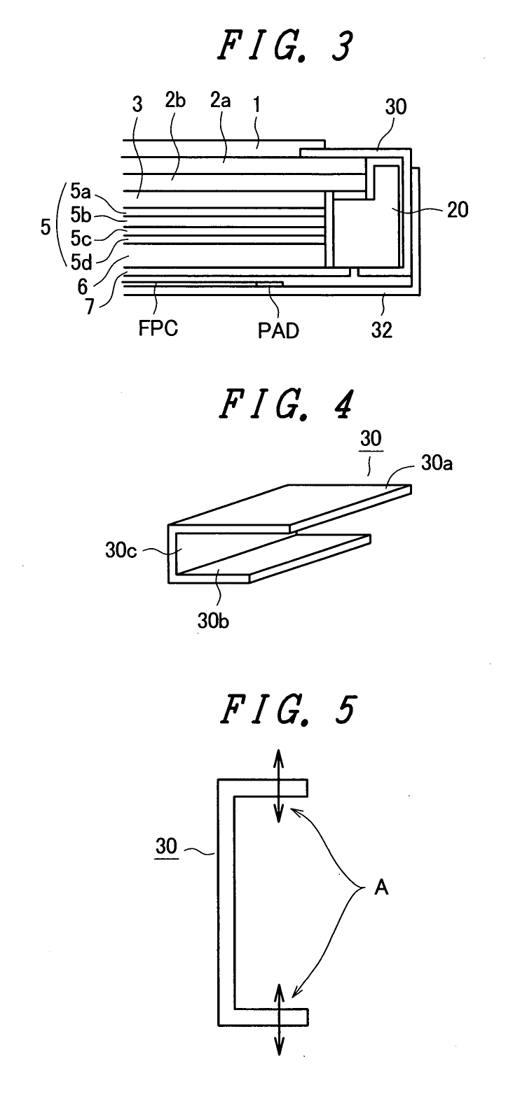

However, in this embodiment, the metal frame 30 is brought into contact with the substrate 2a of the liquid crystal display panel 10, the metal frame 30 is brought into contact with the lower frame 32 and, further, as shown in FIG. 3, the lower frame 32 is brought into contact with a predetermined terminal (PAD) on a flexible printed circuit board (FPC) which extends to the back side of backlight. Due to such a constitution, the static electricity can be eliminated thus preventing the occurrence of the abnormal display on the liquid crystal display panel 10.

The liquid crystal display panel 10 may adopt either a vertical electric field method or a lateral electric field method. When the liquid crystal display panel 10 adopts the vertical electric field method, counter electrodes are formed on a liquid-crystal-side surface of the substrate 2a.

However, when the liquid crystal display panel 10 adopts the lateral electric field method, in general, the liquid crystal display panel 10 is configured such that counter electrodes are formed on the substrate 2b side, and electrodes are not formed on a liquid-crystal-side surface of the substrate 2a. In this case, a transparent conductive film is formed on the viewer-side surface of the substrate 2a thus preventing charging. The conductivity may be ensured by bringing the transparent conductive film and the metal frame 30 into contact with each other.

As shown in FIG. 1, the substrate 2a is smaller than the substrate 2b in size and hence, there exists a portion of the substrate 2b on which the substrate 2a is not present. Further, a stepped portion 2c is formed between the substrate 2a and the substrate 2b.

In holding the liquid crystal display panel 10 using the metal frames 30, when the liquid crystal display panel 10 is held only at the portion of the substrate 2b on which the substrate 2a is not present, there exists a possibility that the substrate cracks. Accordingly, it is desirable to hold the liquid crystal display panel 10 from above the substrate 2a using the metal frame 30.

Here, in FIG. 1, the metal frame 30 is arranged only in the vicinity of the stepped portion 2c between the substrate 2a and the substrate 2b. Due to such a constitution, it is possible to reduce a size of the metal frame 30.

Further, when the liquid crystal display panel 10 is held at a region outside a region in which the upper polarizer 1 is arranged for reducing the thickness of the liquid crystal display panel 10, it is possible to hold the liquid crystal display panel 10 using a region ranging from a side 1a on the stepped portion 2c side to the stepped portion 2c out of respective sides of the upper polarizer 1 and hence, a large holding region can be ensured. Particularly, by arranging the metal frames 30 such that the stepped portion 2c and the metal frames 30 are overlapped to each other, it is possible to make use of a picture frame region of the substrate 2a up to a position ultimately close to the stepped portion 2c.

Further, when the flexible printed circuit board FPC is mounted on the liquid crystal display panel 10 such that the flexible printed circuit board FPC is connected to the substrate 2b and is folded back to the back side of the backlight, there arises a drawback that the liquid crystal display panel 10 is lifted due to a bending repulsive force (spring back force) of the flexible printed circuit board FPC. However, as shown in FIG. 1, by arranging the metal frames 30 at the portion of the stepped portion 2c where a connection side of the flexible printed circuit board FPC is arranged, it is possible to effectively prevent such lifting of the liquid crystal display panel 10.

Further, the pair of metal frames 30 is not brought into contact with each other and hence, even when irregularities are found in sizes of the metal frames 30 (irregularities in sizes of a first plate-like member 30a in FIG. 4), there is no possibility that a profile size of the liquid crystal display panel 10 in the lateral direction is increased.

FIG. 4 is a perspective view for explaining the metal frames 30 shown in FIG. 1.

The metal frame 30 of this embodiment includes the first plate-like member 30a which is brought into contact with the substrate 2a of the liquid crystal display panel 10, a second plate-like member 30b which is brought into contact with the frame-like mold 20 of the backlight, and a third plate-like member 30c which connects one end of the first plate-like member 30a and one end of the second plate-like member 30b. Here, in FIG. 4, a length of the first plate-like member 30a is set larger than a length of the second plate-like member 30b.

The metal frame 30 holds the liquid crystal display panel 10 and the frame-like mold 20 which are inserted into the inside of a space defined by the first plate-like member 30a, the second plate-like member 30b and the third plate-like member 30c by sandwiching the liquid crystal display panel 10 and the frame-like mold 20 between the first plate-like member 30a and the second plate-like member 30b.

In this manner, the metal frame 30 which is formed to have the U-shaped cross section is, as indicated by symbol A in FIG. 5, exhibits resiliency against a weight applied in the direction to open or narrow the U-shaped cross section and hence, the metal frame 30 functions like a clip. Accordingly, the metal frame 30 can hold the whole liquid crystal display module from the left and right sides by making use of this property of the metal frames 30.

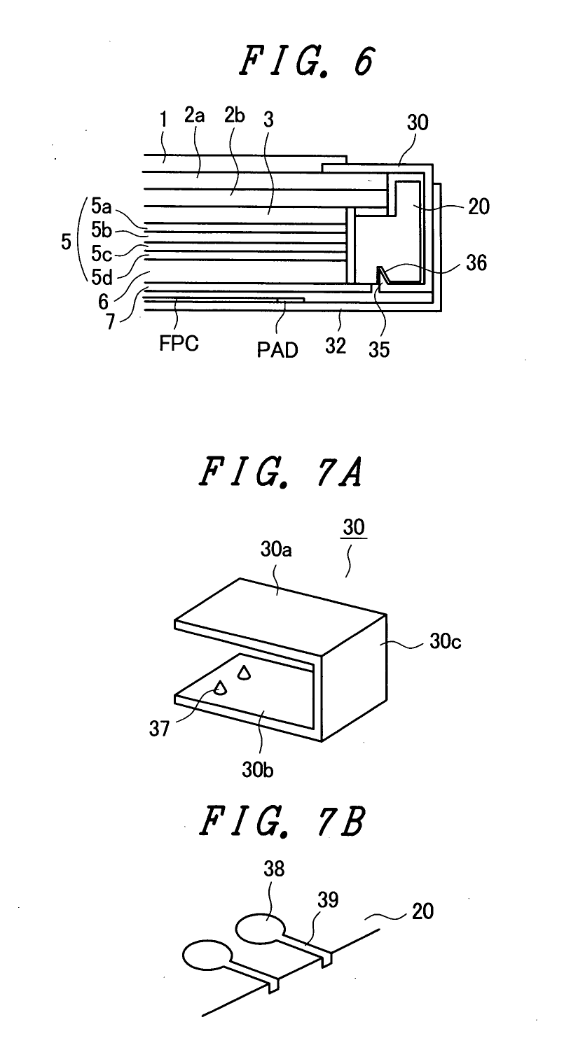

FIG. 6 is a view showing a modification of the metal frames 30 shown in FIG. 1.

The metal frame 30 shown in FIG. 6 is configured such that projecting portions 35 are formed on a distal end of the second plate-like member 30b and, at the same time, recessed portions 36 are formed in portions of the mold 20 with which the second plate-like member 30b of the metal frame 30 is brought into contact, and the projecting portions 35 formed on the tip of the second plate-like member 30b of the metal frame 30 are inserted into the recessed portions 36 of the mold 20 thus preventing the removal of the metal frame 30.

FIG. 7A and FIG. 7B show another modification of the metal frame 30 shown in FIG. 1.

As shown in FIG. 7A, the metal frame 30 is configured such that projecting portions 37 are formed on an inner side of the second plate-like member 30b and, at the same time, as shown in FIG. 7B, recessed portions 38 and guide grooves 39 are formed in portions of the mold 20 with which the second plate-like member 30b of the metal frame 30 is brought into contact, and the projecting portions 37 formed on the second plate-like member 30b of the metal frame 30 are inserted into the recessed portions 38 by way of the guide grooves 39 of the mold 20 thus preventing the removal of the metal frame 30. Here, FIG. 7B is a view as viewed from a lower side of the mold 20.

The embodiment has following manner of operation and advantageous effects.

(1) It is no more necessary to ensure the inner clearance (KA shown in FIG. 15) which is to be ensured conventionally.

(2) The embodiment can cope with the irregularities in thicknesses of the sheets 5 in the inside of the mold 20 or the thicknesses of light guide plate 6 in the inside of the mold 20.

(3) In establishing the conductivity between the liquid crystal display panel 10 and the upper frame, it is no more necessary to sandwich the conductive material (the tape or the like having both properties of adhesiveness and conductivity or the conductive sheet or the like having resiliency such as the conductive rubber) between the liquid crystal display panel 10 and the upper frame.

### Embodiment 2

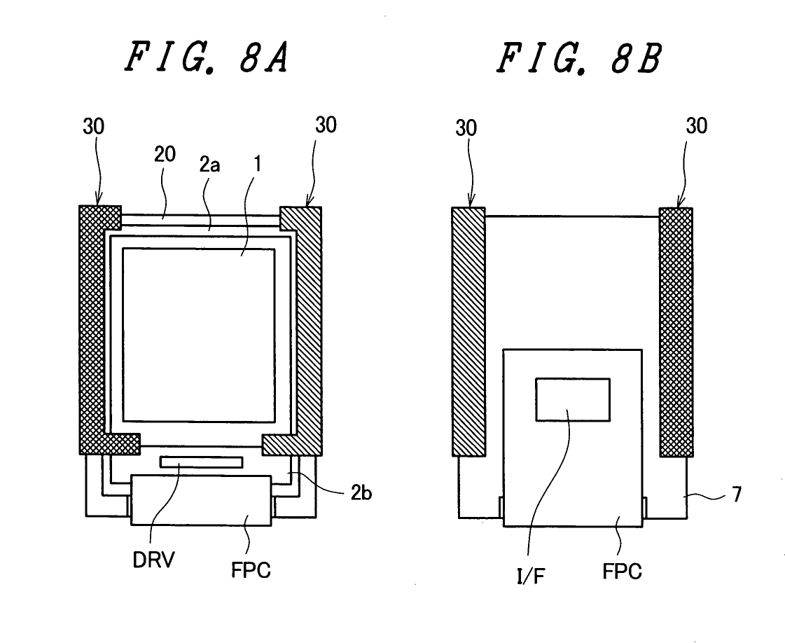

FIG. 8A and FIG. 8B are views showing the schematic structure of a liquid crystal display module for a mobile phone of an embodiment 2 according to the present invention, wherein FIG. 8A is a front view of the liquid crystal display module, and FIG. 8B is a back view of the liquid crystal display module.

In this embodiment, a pair of metal frames 30 is arranged on longitudinal end portions of the liquid crystal display panel 10 to cover the longitudinal end portion of the liquid crystal display panel 10 along the longitudinal direction of the liquid crystal display panel 10.

Here, in FIG. 8A and FIG. 8B, numeral 1 indicates an upper polarizer, symbols 2a, 2b indicate a substrate, numeral 7 indicates a reflection sheet, numeral 20 indicates a mold, symbol DRV indicates a semiconductor chip, symbol FPC indicates a flexible printed circuit board and, as shown in FIG. 8B, the flexible printed circuit board (FPC) has another end thereof folded back and arranged on a backside of the backlight. Further, symbol I/F indicates a connecting portion with the outside.

Here, in this embodiment and respective embodiments described later, a lower frame 32 may be provided to increase a strength (rigidity) of the whole liquid crystal display module.

### Embodiment 3

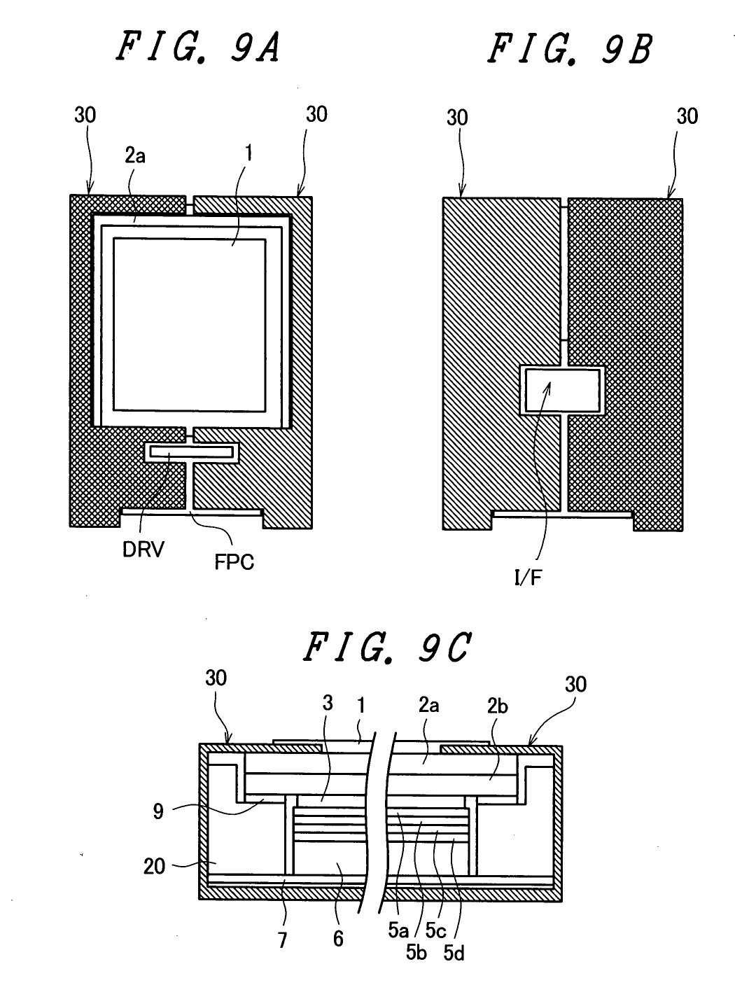

FIG. 9A to FIG. 9C are views showing the schematic structure of a liquid crystal display module for a mobile phone of an embodiment 3 according to the present invention, wherein FIG. 9A is a front view of the liquid crystal display module, FIG. 9B is a back view of the liquid crystal display module, and FIG. 9C is a cross-sectional view of an essential part of the liquid crystal display module.

In this embodiment, a pair of metal frames 30 is arranged to cover a liquid crystal display panel 10 except for a display part of the liquid crystal display panel 10 and a semiconductor chip (DRV). It is desirable that the left and right frames 30 are not brought into contact with each other. Due to such a constitution, the pair of metal frames 30 can absorb the irregularities in size of the liquid crystal display module.

Here, in FIG. 9A to FIG. 9C, numeral 1 indicates an upper polarizer, symbols 2a, 2b indicate a substrate, symbol 5a indicates an upper diffusion sheet, symbols 5b, 5c indicate a prism sheet, symbol 5d indicates a lower diffusion sheet, numeral 6 indicates a light guide plate, numeral 7 indicates a reflection sheet, symbol DRV indicates a semiconductor chip, symbol FPC indicates a flexible printed circuit board, and symbol I/F indicates a connection portion with the outside.

In this embodiment, while another end of the flexible printed circuit board (FPC) is folded back to the back side of the backlight, a portion of the flexible printed circuit board (FPC) which is folded back to the back side of the backlight is inserted into the inside of the pair of metal frames 30. Accordingly, recessed portions which allow the exposure of the connection portion (I/F) with the outside are formed in the pair of metal frames 30.

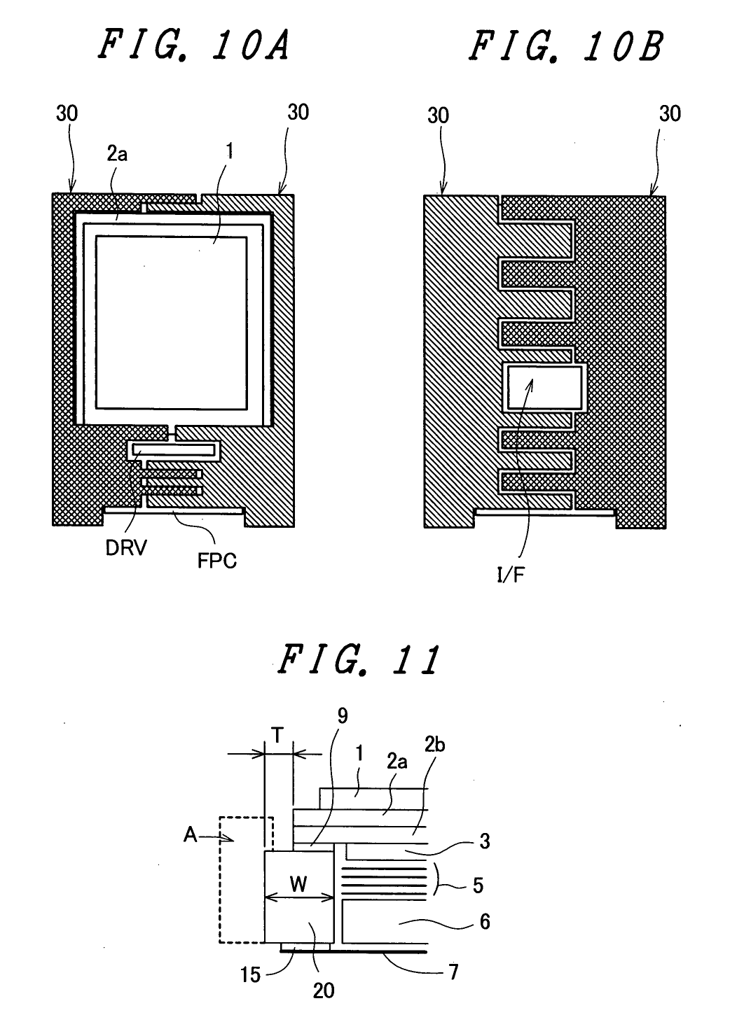

FIG. 10A and FIG. 10B are views showing the schematic structure of a modification of a liquid crystal display module for a mobile phone of the embodiment 3 according to the present invention, wherein FIG. 10A is a front view of the liquid crystal display module, and FIG. 10B is a back view of the liquid crystal display module.

In the liquid display module shown in FIG. 10A and FIG. 10B, the pair of metal frames 30 has portions thereof which face each other formed in a corrugated shape (so-called comb-teeth shape), and convex portions of one metal frame 30 are inserted into the inside of recessed portions of another metal frame 30.

Here, in FIG. 10A and FIG. 10B, numeral 1 indicates an upper polarizer, symbol 2a indicates a substrate, symbol DRV indicates a semiconductor chip, symbol FPC indicates a flexible printed circuit board, and symbol I/F indicates a connection portion with the outside.

As shown in FIG. 10A and FIG. 10B, in case of the structure which brings the pair of metal frames 30 into comb-teeth meshing engagement, as shown in FIG. 9A to FIG. 9C, it is possible to increase the rigidity of the liquid crystal display module against a stress in the longitudinal direction compared to the structure which divides the pair of metal frames 30 to the left and right sides with respect to the center.

### Embodiment 4

Hereinafter, a modification of the backlight used in the above-mentioned respective embodiments is explained as a embodiment 4 of the present invention.

FIG. 11 is a cross-sectional view of an essential part for explaining a backlight of the embodiment 4 according to the present invention.

As shown in FIG. 11, in this embodiment, the mold 20 does not have a side wall 20a and, at the same time, a width (W in FIG. 11) of the mold 20 is set narrower than a width of the mold 20 of the conventional liquid crystal display module.

Further, in this embodiment, a predetermined distance (T in FIG. 11) is provided between an end surface (end surface of the substrates (2a, 2b)) (side surface) of the liquid crystal display panel and the side surface of the mold 20.

As shown in FIG. 19A, when the thickness of the substrates (2a, 2b) is large, (for example, the total thickness of two substrates (2a, 2b) is approximately 1 mm), as shown in FIG. 19B, a height of the side wall 20a of the mold 20 is sufficiently high and hence, it is possible to easily make the substrates (2a, 2b) abut against a side wall 20a.

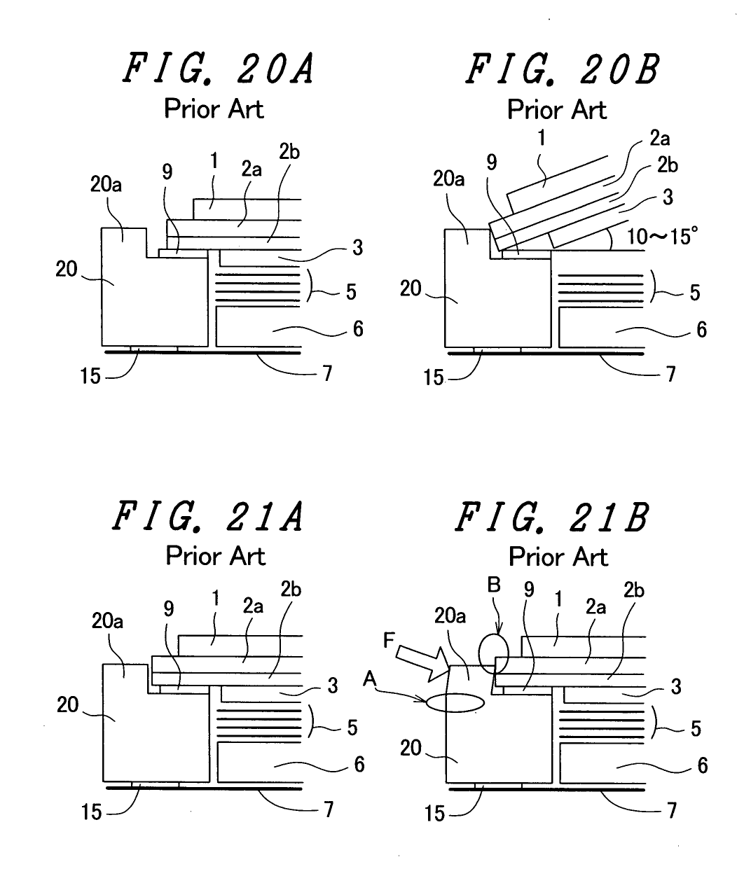

However, since the side wall 20a of the mold 20 is designed to be slightly lower than the substrate 2a of the liquid crystal display panel 10, as shown in FIG. 20A, when the thicknesses of the substrates (2a, 2b) become small, the height of the side wall 20a of the mold 20 is lowered.

Accordingly, as shown in FIG. 20B, in performing the abutting assembling to enhance the assembling accuracy of the liquid crystal display panel 10, the operability of the assembling is deteriorated. For example, when the total thickness of two substrates (2a, 2b) becomes 0.6 mm or less, the operability is remarkably deteriorated.

Further, as shown in FIG. 21A, when the abutting assembling is performed with the liquid crystal display panel 10 having the substrates (2a, 2b) with small thicknesses, an end surface of the liquid crystal display panel 10 is liable to be easily brought into contact with an inner surface of the side wall 20a of the mold 20.

Further, as shown in FIG. 21B, in a state that the end surface of the liquid crystal display panel 10 is brought into close contact with the inner wall of the side wall 20a of the mold 20, the sidewall 20a of the mold 20 is deformed by an external force F as indicated by A in FIG. 21B and an indirect stress is, as indicated by B in FIG. 21B, directly transmitted to the substrates (2a, 2b) thus giving rise to a possibility that the substrate is cracked. Here, in FIG. 19A, FIG. 19B, FIG. 20A, FIG. 20B, FIG. 21A and FIG. 21B, numeral 15 indicates a pressure-sensitive adhesive double-coated tape, and a reflection sheet 7 is fixed to a lower side of the mold 20 using a pressure-sensitive adhesive double-coated tape 15.

However, in this embodiment, the mold 20 does not have the sidewall 20a and forms a planar shape and hence, it is possible to prevent the generation of the phenomenon that the side wall 20a of the mold 20 is deformed and the indirect stress is directly transmitted to the substrates (2a, 2b) of the liquid crystal display panel 10 thus cracking the substrate.

Further, in this embodiment, the predetermined distance (T in FIG. 11) is provided between the end surface (the end surface of the substrates (2a, 2b)) of the liquid crystal display panel and the side surface of the mold 20. Accordingly, even when vibrations or the like are applied to the liquid crystal display module, the distance prevents the substrates (2a, 2b) of the liquid crystal display panel 10 from being in contact with the metal frame 30 (the lower frame 32 when the lower frame 32 is used) and hence, it is possible to prevent a phenomenon that an indirect stress is transmitted to the substrates (2a, 2b) of the liquid crystal display panel 10 thus cracking the substrate.

Here, the predetermined distance (T in FIG. 11) may be preferably set to 0.3 mm≦T≦1 mm.

This embodiment adopts the structure in which a resin is not interposed between the side surface of the liquid crystal display panel 10 and the metal frame 30 (the lower frame 32 when the lower frame 32 is used).

Accordingly, in this embodiment, a width of the mold 20 (W in FIG. 11) can be narrowed by an amount corresponding to a portion indicated by A in FIG. 11 (a portion of the side wall having a width of approximately 0.6 mm). Further, in a state that the liquid crystal display module is assembled into the inside of the pair of metal frames 30, it is possible to achieve the further miniaturization of a profile size of the liquid crystal display module.

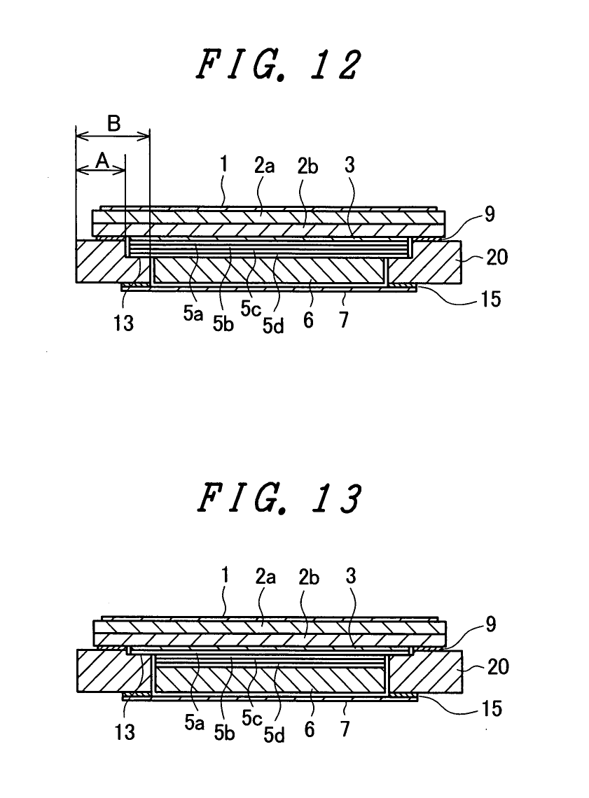

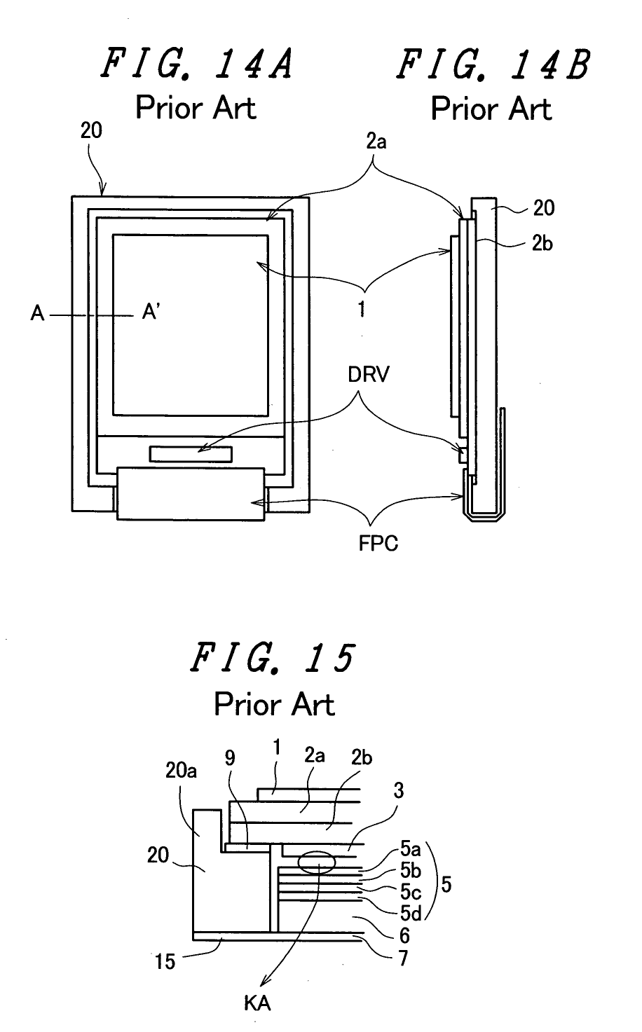

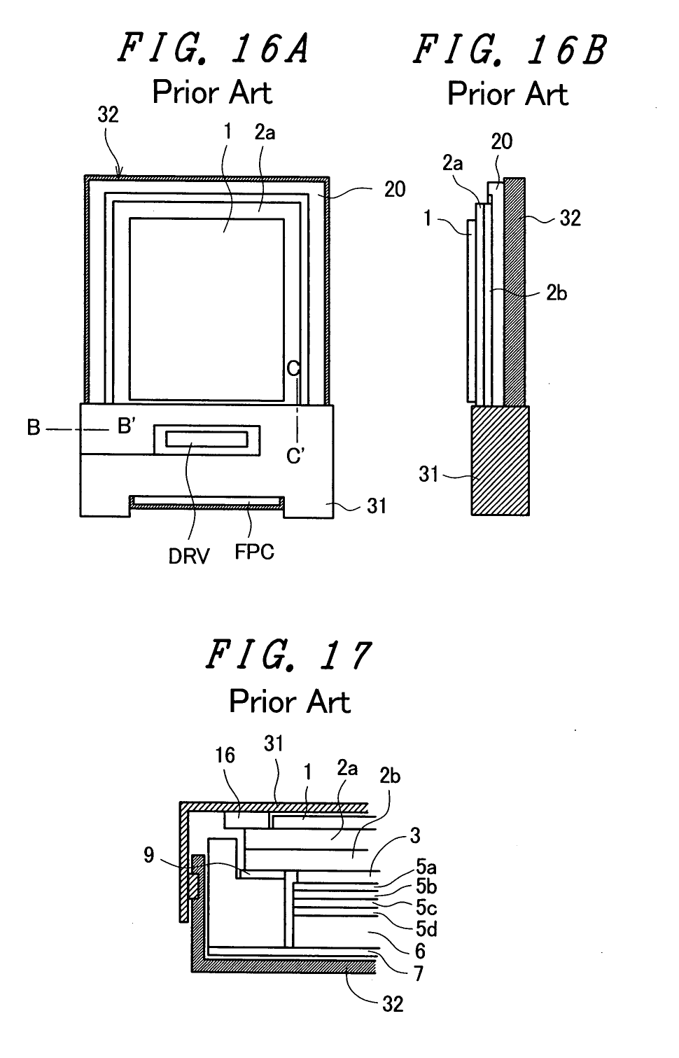

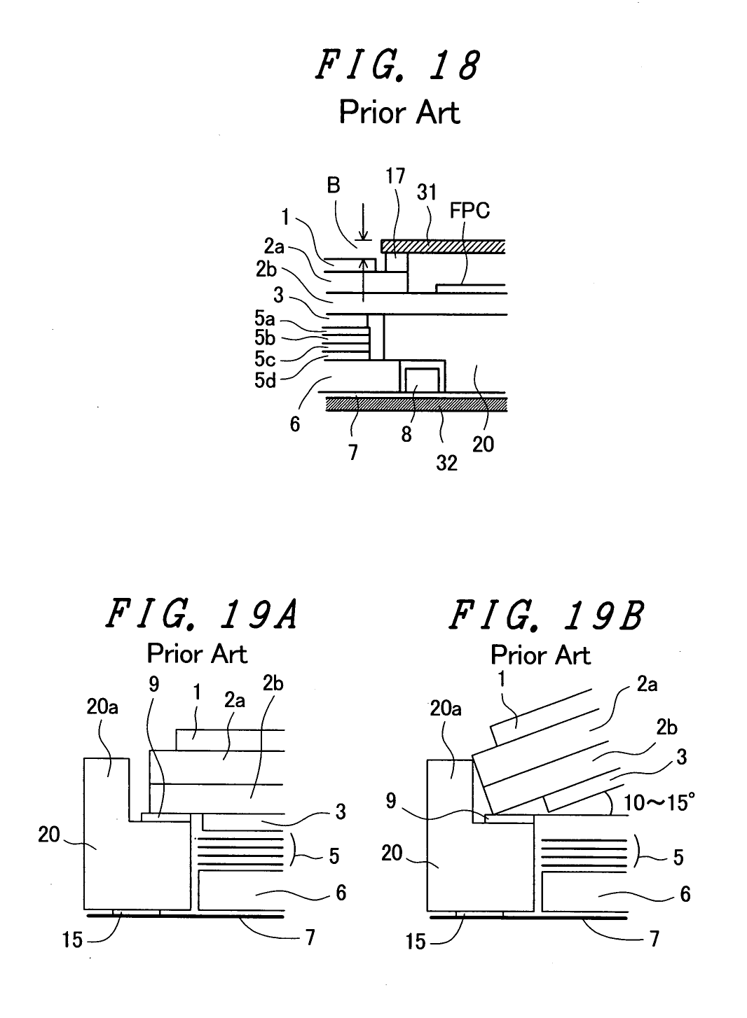

FIG. 12 is a cross-sectional view of an essential part for explaining a modification of the mold 20 shown in FIG. 11.

The mold 20 of this embodiment adopts the structure in which a bottom surface is eliminated and an opening portion is formed at a center portion thereof, that is, a frame-like body (or a cylindrical body) having an approximately quadrangular cross section. In the example shown in FIG. 12, a size of a light guide plate 6 is set to a necessary minimum size, for example, to a size which is obtained by adding a region of a necessary minimum to a size of a pixel region of a liquid crystal display panel 10 by taking irregularities such as matching displacement into consideration or a size which ensures a minimum region necessary for injection molding.

Accordingly, the modification shown in FIG. 12 adopts the structure in which a frame width of the mold 20 surrounding the light guide plate 6 is increased to make the mold 20 approach the light guide plate side. That is, in the modification shown in FIG. 12, two sides of the mold 20 (preferably long sides of the mold 20) (sides orthogonal to an incident surface of the light guide plate 6) respectively have a first portion and a second portion which change a distance between these portions and opposing sides in a step-like manner.

Here, the second portion (the portion indicated by B in FIG. 12) sets the distance between the second portion and the opposing side smaller than the distance between the first portion (the portion indicated by A in FIG. 12) and the opposing side. Further, a peripheral portion of the substrate 2b of the liquid crystal display panel 10 (a region ranging from the outside of a lower polarizer 3 to an end surface of the liquid crystal display panel 10) is supported on and is fixed to the first portion A of the mold 20 using a pressure-sensitive adhesive double-coated tape (adhesive member) 9.

Further, a stepped portion 13 is formed of the first portion A and the second portion B and a group of optical sheets 5 is supported on the stepped portion 13. Further, a light guide plate 6 is arranged inside the second portion B. Below the light guide plate 6, a reflection sheet 7 is arranged to cover the opening portion of the mold 20. The reflection sheet 7 is supported on and is fixed to a back surface side of the mold 20 using a pressure-sensitive adhesive double-coated tape 15.

Since the light guide plate 6 is arranged on the second portion B, an area of the light guide plate 6 can be reduced. Accordingly, it is possible to increase the luminance per unit area.

Further, in the modification shown in FIG. 12, an end portion of the lower polarizer 3 is positioned within the stepped portion 13. That is, as viewed in a plan view, the end portion of the lower polarizer 3 is overlapped to the stepped portion 13.

Here, in the modification shown in FIG. 12, as a method for making the inner wall of the mold 20 approach the light guide plate 6, either one of a method which partially increases the thickness of the mold 20 and a method which moves a position of the wall toward the inside while maintaining the same frame width may be selected.

From a viewpoint of enhancing durability, as shown in FIG. 12, it is desirable to increase the frame width of the frame-like mold 20 at the second portion B than the fist portion A.

Due to such a constitution, in the modification shown in FIG. 12, it is possible to enhance the luminance compared to the conventional structure while realizing the reduction of the thickness of the liquid crystal display module.

Here, in this embodiment, a group of the optical sheets 5 which is supported on the stepped portion 13 may be constituted of at least one optical sheet.

FIG. 13 is a cross-sectional view of an essential part for explaining another modification of the mold 20 shown in FIG. 11.

For example, as shown in FIG. 13, out of the group of optical sheets 5, an upper diffusion sheet 5a may be supported on the stepped portion 13, and other optical sheets (two lens sheets (5b, 5c) and a lower diffusion sheet 5d) may be arranged inside the second portion B and above the light guide plate 6.

Here, as shown in FIG. 13, the upper diffusion sheet 5a among the group of the optical sheets 5 is supported on the stepped portion 13 for preventing dusts or the like from intruding into the inside of the second portion B.

Here, the constitution of the group of optical sheets 5 is not limited to the above-mentioned constitution and hence, it is sufficient that at least one optical sheet is arranged above the stepped portion 13 and the number of the optical sheets which are arranged inside the second portion B is not particularly limited.

Although the inventions which are made by inventors of the present inventions are specifically explained in conjunction with the above-mentioned embodiments heretofore, it is needless to say that the present invention is not limited to the above-mentioned embodiments and various modifications are conceivable without departing from the gist of the present invention.

What is claimed is:

1. A liquid crystal display device comprising:
a liquid crystal display panel which includes a pair of substrates and liquid crystal sandwiched between the pair of substrates;
a backlight which is arranged on a side of the liquid crystal display panel opposite to a viewer, the backlight having a frame-like mold; and
a pair of frames which are arranged along two longitudinal sides of the liquid crystal display panel and sandwiches the liquid crystal display panel and the backlight, wherein
each frame of the pair of frames includes a first plate-like member, a second plate-like member, and a third plate-like member which connects one end of the first plate-like member and one end of the second plate-like member, and
the pair of frames holds the liquid crystal display panel and the frame-like mold which are inserted into the inside of a space defined by the first plate-like member, the second plate-like member and the third plate-like member by sandwiching the liquid crystal display panel and the frame-like mold using the first plate-like member and the second plate-like member.

2. A liquid crystal display device according to claim 1, wherein a projecting portion which projects toward the first plate-like member is formed on the second plate-like members of the pair of frames,
a recessed portion is formed in the frame-like mold of the backlight, and
the projecting portion which is formed on the second plate-like member of the frame is inserted into the inside of the recessed portion formed on the frame-like mold of the backlight.

3. A liquid crystal display device according to claim 2, wherein the frame-like mold of the backlight has a guide groove which is continuously formed to be communicated with the recessed portion from a side surface of the frame-like mold.

4. A liquid crystal display device according to claim 1, wherein the pair of frames is not brought into direct contact with each other.

5. A liquid crystal display device according to claim 1, wherein the pair of frames respectively has a same shape.

6. A liquid crystal display device according to claim 1, wherein the liquid crystal display panel includes an upper polarizer over the substrate on the viewer side out of the pair of substrates, and
the frame is arranged in a region outside a region in which the upper polarizer is arranged.

7. A liquid crystal display device according to claim 6, wherein the liquid crystal display panel includes a semiconductor chip on the substrate opposite to the viewer out of the pair of substrates, and the frame is arranged in a region outside a region in which the upper polarizer is arranged and a region outside a region in which the semiconductor chip is arranged.

8. A liquid crystal display device according to claim 1, wherein the pair of frames is made of metal, and the pair of frames is brought into contact with the substrate of the liquid crystal display panel on the viewer side.

9. A liquid crystal display device according to claim 1, wherein the pair of frames is arranged to cover the liquid crystal display panel except for a display part of the liquid crystal display panel.

10. A liquid crystal display device according to claim 9, wherein the pair of frames has portions of one frame and another frame which face each other formed in a corrugated shape between one frame and another frame, and the corrugated shape is configured such that convex portions of one frame out of the pair of frames is inserted into the inside of recessed portions of another frame of the pair of frames.

11. A liquid crystal display device according to claim 9, wherein the liquid crystal display device includes a flexible printed circuit board which has one end thereof fixed to an end portion of the substrate of the liquid crystal display panel on a side opposite to a viewer and another end thereof arranged on a back side of the backlight, and
the pair of frames is arranged to cover the flexible printed circuit board.

12. A liquid crystal display device according to claim 1, wherein the pair of frames is arranged on longitudinal end portions of the liquid crystal display panel to cover the longitudinal end portion of the liquid crystal display panel along the longitudinal direction of the liquid crystal display panel.

13. A liquid crystal display device according to claim 1, wherein the pair of frames is arranged only in the vicinity of a stepped portion between one substrate and another substrate of the liquid crystal display panel in a state that the pair of frames is overlapped to the stepped portion.

14. A liquid crystal display device according to claim 13, wherein the pair of frames sets a length of the first plate-like member larger than a length of the second plate-like member.

15. A liquid crystal display device according to claim 1, wherein the liquid crystal display device includes a lower frame, and the liquid crystal display panel, the backlight and the pair of frames are housed in the inside of the lower frame.

16. A liquid crystal display device according to claim 1, wherein the liquid crystal display panel has the substrate on a side opposite to a viewer fixed to a surface of the frame-like mold on the viewer side,
a side surface of the liquid crystal display panel is retracted toward the inside of the frame-like mold than a side surface of the frame-like mold, and the liquid crystal display panel and the frame-like mold are housed in the inside of the frame without interposing a resin between the side surface of the liquid crystal display panel and the pair of frames.

17. A liquid crystal display device according to claim 16, wherein a distance between a side surface of the frame-like mold and a side surface of the liquid crystal display panel is set to a value equal to or more than 0.3 mm and equal to or less than 1 mm.

18. A liquid crystal display device according to claim 1, wherein the liquid crystal display panel includes a lower polarizer on the substrate on a side opposite to the viewer, and
the liquid crystal display panel is fixed to a surface of the frame-like mold on the viewer side in a region ranging from the outside of the lower polarizer to an end portion of the liquid crystal display panel.

19. A liquid crystal display device according to claim 1, wherein the liquid crystal display panel is fixed to a surface of the frame-like mold on the viewer side using a pressure-sensitive adhesive double-coated tape.
